(19) United States
(12) Patent Application Publication
(10) Pub. No.: US 2026/0133300 A1
(43) Pub. Date: May 14, 2026

(54) TECHNIQUES AND SYSTEMS FOR AUTO-CALIBRATING COHERENT DETECTION

(71) Applicant: Omer Pars KOCAOGLU, Izmir (TR)

(72) Inventor: Omer Pars KOCAOGLU, Izmir (TR)

(21) Appl. No.: 19/119,579

(22) PCT Filed: Oct. 4, 2023
(86) PCT No.: PCT/US2023/034414

§ 371 Date: Apr. 9, 2025

Related U.S. Application Data
(60) Provisional application No. 63/417,329, filed on Oct. 19, 2022.

(51) Int. Cl. G01S 7/497; G01S 7/481

(52) U.S. Cl. CPC G01S 7/497; G01S 7/4818

(57) ABSTRACT

Coherent detection methods, with an optical source emitting frequency chirped or wavelength swept light, split optical beam into two main paths: target path and reference path (local oscillator). Target path sends portion of the light to environment for sensing. Reference path sends portion of the light to a path that generates a known propagation delay. Light returning from both paths are mixed together (interferometer) to generate a beat signal that represents the propagation delay difference between the two paths. The beat signals obtained in these systems need to be calibrated for removing any imperfections and nonlinearities due to frequency chirping or wavelength sweeping process issues or any other noise sources. Current disclosure describes coherent detection systems and methods that calibrate out beat signal imperfections using any internal reflections returning from target path without adding an additional calibration interferometer or detectors.

### TECHNICAL FIELD

The present disclosure relates generally to coherent detection applications like light detection and ranging (LIDAR) and optical coherence tomography (OCT) systems and methods that provide range and velocity measurements across multiple dimensions.

Background: Calibration for coherent detection systems like LIDAR and OCT has been limited to use of an additional interferometer. However, the additional interferometer adds complexity and cost to these systems making their use limited in some applications like self-driving vehicles.

### SUMMARY

The present disclosure describes example coherent detection system and method for self-calibration of beat signal imperfections without using an additional interferometer for reducing complexity and cost for systems like LIDAR or OCT.

Coherent light detection systems split the emitted frequency chirped (wavelength swept) light from optical source into two paths: target path and reference path (local oscillator). Target path sends portion of the light to environment for sensing, reference path sends portion of the light to a path that generates a known propagation delay. Light returning from both paths are mixed together (interferometer) to generate a beat signal that represents the propagation delay difference between the two paths. This beat signal needs calibration for removing any imperfections and non-linearities due to frequency chirping process being less than perfectly linear or other noise sources. Coherent systems use an additional internal interferometer that receives a portion of chirped or swept light from the optical source to create a beat signal with a known frequency (calibration signal). This simultaneously recorded calibration signal is used to eliminate or reduce any imperfections in the beat signal that is recorded from target space.

Current disclosure describes, without limitation, following examples:

In one example, a coherent detection system and method that calibrates out target space beat signal imperfections without using an additional calibration interferometer, detectors or any additional beat signal from a non-target path source. Any reflection coming back from the target path optical components, like a surface reflection that occur from an interface between air and a component with different refractive index higher than air, is used for mixing with the light from the refence path or local oscillator for calculating and calibrating out beat signal imperfections and non-linearities. This system and method also eliminate any issues that may stem from the time gap between the arrivals of calibration and target signals, such as beat signal phase mismatches, hence it eliminates the necessity for any phase correction between the two.

In one example, a reflection that occurs at the target path's fiber tip which has a surface interface of fiber core and air with a refractive index mismatch at a known location will generate a beat signal when mixed with the light from reference path or local oscillator. Since the range correspondence between this beat signal and the location of fiber tip is known, a calibration function can be calculated. In this example and all other examples below, no phase correction for target and calibration beat signals would be needed since the calibration function is embedded in the target signal itself. In this case, any phase correction functions that are calculated for the calibration beat signal is directly applicable to the target signal.

In one example, for a photonic integrated circuit (PIC), a reflection that occurs at the target path of the PIC or at the remainder of the target path that is outside the PIC. with a refractive index mismatch at a known location will generate a beat signal when mixed with the light from reference path or local oscillator. Since the range correspondence between this beat signal and the location of this surface is known, a calibration function can be calculated.

In one example, a reflection that occurs at one of the optical components of the target path such as a lens, wave plate, a polarization sensitive splitter, a window, a mirror or a partial or full reflector from a known location will generate a beat signal when mixed with the light from reference path or local oscillator. Since the range correspondence between this beat signal and the location of this surface is known, a calibration function can be calculated.

In one example, when no natural reflection returns from the target path that is usable for self-calibration, a partially or fully reflective component that has partial spatial coverage on the target path is inserted in the target path for generating a beat signal when mixed with the light from reference path or local oscillator. Since the range correspondence between this beat signal and the location of this surface is known, a calibration function can be calculated.

In one example, when no natural reflection returns from the target path that is usable for self-calibration, a partially reflective component that has partial or full spatial coverage on the target path is inserted in the target path for generating a beat signal when mixed with the light from reference path or local oscillator. Since the range correspondence between this beat signal and the location of this surface is known, a calibration function can be calculated.

In one example, calibration beat signal is isolated from targets using its frequency range and imperfections or non-linearities are removed by using its unwrapped phase information to linearize the evolution of its phase over the acquisition period.

In one example, the calibration of beat signal phase is performed by using the zero crossings of each sinusoidal-like wave.

In one example, the calibration of beat signal phase is performed by using the peak locations of each sinusoidal-like wave.

In one example, the calibration of beat signal phase is performed by using a sine wave curve fitting to sinusoidal-like waves.

In one example, a multiplexed version of any one or combination of the above examples are used to obtain calibration or calibrations for multiple optical beams from coherent or non-coherent optical source or sources separated by frequency, wavelength, polarization state or multiplexing with any other method.

In one example, light from optical source or sources are amplified together or individually using optical amplifier of any kind for any one or combination of the above examples at any location of the apparatus.

Above-described methods and systems as well as other details of the present disclosure will be further clarified in below detailed description and accompanied figures. Brief descriptions of the figures are below. The present disclosure includes any combination of multiple features or elements set forth in this disclosure whether or not such features or elements are expressly combined or otherwise recited in examples described herein. Any separable features or elements of this disclosure in any example should be considered as combinable unless dictated otherwise in the disclosure.

### BRIEF DESCRIPTION OF THE DRAWINGS

For better understanding of the given examples, more detailed descriptions and accompanying drawings are referenced in connection with identifiers and corresponding elements.

FIG. 1 is a block diagram illustrating an example LIDAR or OCT system according to the present disclosure;

FIG. 2 is illustrating an example LIDAR or OCT system with various example natural calibration reflection locations from the target path according to the present disclosure;

FIG. 3 is illustrating an example LIDAR or OCT system with multiplexed optical sources and multiplexed detectors with calibration reflection from the target path according to the present disclosure; and

FIG. 4 is a flow diagram illustrating self-calibration method.

### DETAILED DESCRIPTION

The present disclosure describes examples of coherent detection apparatus and method for applications like LIDAR and OCT. The system incorporates some or all types of following component types: fiber optic components, free-space optical components, highly coherent or low coherent optical source or sources creating single or multiple optical beams, waveguides, PICs, and optical components integrated in silicon photonics. These optical components may include polarization sensitive or polarization independent components for directing, collimating, focusing, separating, combining, detecting the optical beam. This optical system delivers one or multiple optical beams to the target environment and collect the light returning from the target environment. Light returning from the targets get mixed with a local sample (local oscillator or reference beam) of the illumination beam and this mix gets detected by single or multiple optical detectors. Not only the light returning from targets get mixed with the local oscillator, but also the light returning from the components on the illumination path get mixed with it. Therefore, components reflecting a portion of the light back also generate a signal on the detectors (an internal signal). The present disclosure describes example apparatuses and methods for using such internal signal or signals for calculating calibration function or functions and applying them on the target signals to remove any imperfections of target beat signals.

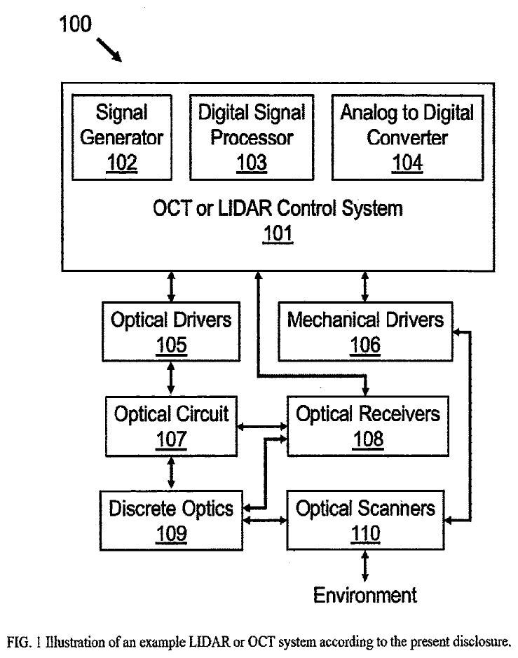

FIG. 1 illustrates a coherent detection system 100 for applications like LIDAR or OCT according to example implementations of the present disclosure. The coherent detection system 100 incorporates one or more of each of a number of components shown in FIG. 1. The coherent detection system 100 may include more or fewer parts than what is shown in FIG. 1. The coherent detection system 100 may be implemented in any one, two, three, four or more-dimensional sensing devices that are used for applications like mapping, surveillance, real-time navigation, route selection, medical diagnosis, velocity, motion, and motion direction. The coherent detection 100 may be incorporated in any above-mentioned sensing devices for any market like defense, robotics, medical, transportation, security, metrology, automation, manufacturing, but not limited to these markets. The coherent detection system 100 includes a control system 101 that may include one or more of each of following components: a signal generator 102, a digital signal processor 103, an analog to digital converter 104. The control system 101 generates signals to activate and maintain the operations of optical, mechanical, and electronic components, collects the signals generated by the sensor coming from internal sources or targets, converts analog signals to digital and processes these digital signals.

The control system 101 controls and maintains the operation of optical drivers 105 and mechanical drivers 106. The signal generator 102 sends out control signals that may be digitally generated and sent out or be converted to analog with a digital-to-analog converter. Optical drivers 105 activates, controls, and maintains safe operation of optical components such as lasers, amplifiers, and any other electro-optic components that manipulate the light within the optical circuit 107, within discrete optics 109, or optical receivers 108. Mechanical drivers 106 activates, controls and maintains safe operation of mechanical and moving components such as optical scanners 110. Optical receivers 108 convert the optical signal into analog electrical signal and send it to the coherent detection control system 101. Optical scanners 110 deliver the optical beam to the environment and collect returning light. Optical scanners 110 may be mechanically moving or rotating components or optical components or electro optical components or optical phased-array or micro electro-mechanical systems (MEMS) or magnetic components for manipulating the propagation direction of the light depending on its frequency or polarization state for sensing various angular directions from the position of the sensing device.

The coherent detection system 100 includes optical circuits 107, optical receivers 108, discrete optics 109, and optical scanners 110. All or any portion of these component may be implemented by using free-space optics, fiber optics, or waveguides in a PIC. The optical circuit 107 may include passive components that guide, reflect, refract, split, combine, polarize the light, active components that generate, amplify, detect, manipulate the light or any combination of both passive and active components that operate with one or multiple frequencies of light.

The control system 101 includes a digital signal processor 103 that may be one or more general- or specific-purpose processing devices, such as field programmable gate array (FPGA), application specific integrated circuit (ASIC), digital signal processor (DSP), microprocessor, central processing unit (CPU) or the like.

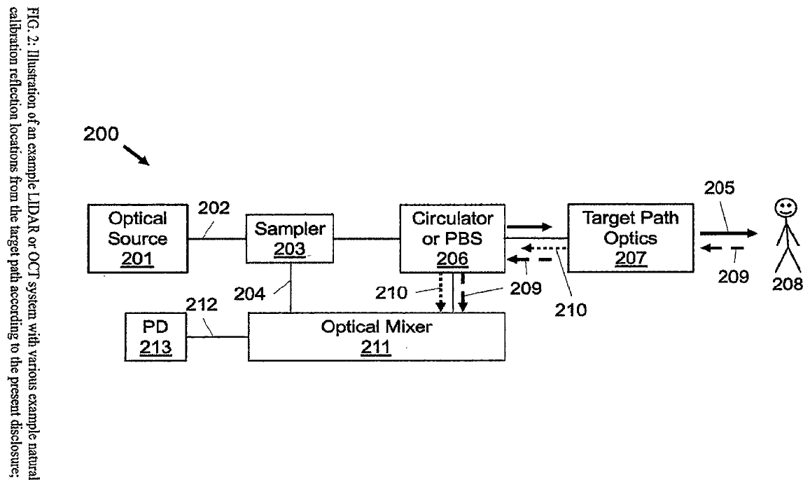

Optical beam is delivered to the environment and signals from returning reflections are collected by the coherent detection optical system 200 is shown in FIG. 2. Optical system components shown in FIG. 2 maybe free space, fiberoptic, or integrated components in a PIC or any combination of all those component types. Optical beam created by source 201 sends the beam 202 to a sampler 203 via a waveguide, a fiber or the like. The sampler 203 routes a portion of the optical beam 204 towards the optical mixer 211 and a portion of the beam 205 towards a circulator, a polarization beam splitter (PBS) 206, or the like. Optical beam 205 from 206 is then delivered to the target environment 208 through target path optics 207. Reflections 210 from target environment 208 are collected and routed back into the system 200 by target path optics 207. Reflections 209 from target path optics 207 or from its interfaces with the rest of the system are routed back into the system along with the target reflections 209. Optical signal from targets 210 and from internal sources 209 are then routed towards the optical mixer 211 by the circulator or PBS or the like 206. Optical mixer 211 mixes the sample light 204 from the sampler 203 with the light from target reflections 210 and with the light from internal reflections 209. The mixed light 212 is routed to the photodetector 213 and gets converted to an electrical signal that oscillates to form beat notes that represent signals in the mixed light 212. The analog beat note signals from 213 (also 108) are then converted into digital signals by the ADC 104 and utilized by the control system 101. Digital signal processor 103 interprets these signals to generate a three-or four-or more-dimensional point cloud.

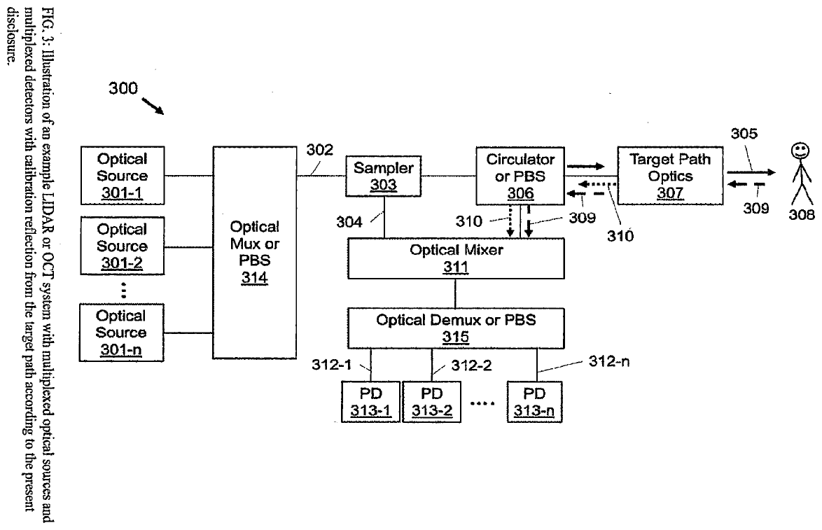

Optical system 300 illustrates a version of system 200 but with plurality of optical sources 301-1 through 301-n and photodetectors 313-1 through 313-n. As for the optical system 200 components the optical system 300 components shown in FIG. 3 also maybe free space, fiberoptic, or integrated components in a PIC or any combination of all those component types. The light from optical sources 301-1 through 301-n are combined into a single optical beam 302 by an optical multiplexer or PBS 314. Optical mixer 311 mixes the sample optical beam containing combined light 304 from the sampler 303 with the combined light from target reflections 310 and with the combined light from internal reflections 309. Optical reflection signals 309 and 310 include light from all optical sources 301. The mixed combined light gets separated into its respective optical-beams 312-1 through 312-n by the optical demultiplexer or PBS 315 and these beams get routed to respective photo detectors 313-1 through 313-n. Light from each optical source 301-1 through 301-n gets routed to a respective photo detector 313-1 through 313-n for accurate separation of beat signals for each source. The analog beat note signals 313-1 through 313-n are then converted into digital signals by the ADC 104 that digitizes the signals using a digitization channel per photodetector. These plurality of digitized beat signals are utilized by the control system 101 and sorted according to their optical source 301. Digital signal processor 103 interprets these signals to generate a three-or four-or more-dimensional point cloud.

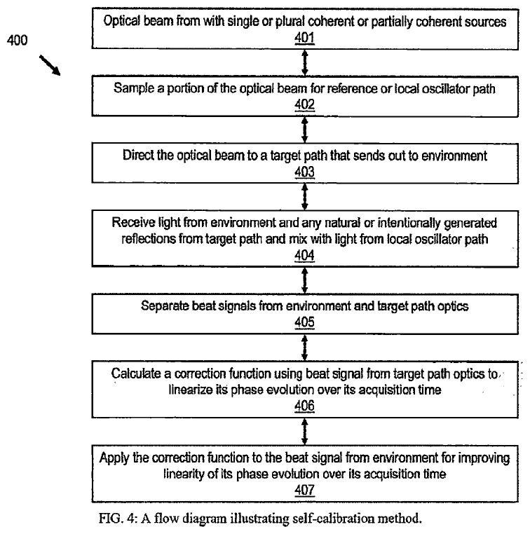

FIG. 4 shows a flow diagram 400 for a coherent detection system 100 illustrating one example of self-calibrated coherent signal processing for generating point clouds or tomographic images or the like. Optical beam from source or sources 401 is routed to sampler 402 and gets separated into two routes reference (local oscillator) path and target path 403. Light from local oscillator and light from target path and from environment are mixed together 404 to generate interference signals. Beat signals from environment and target path optics are separated 405. A correction function is calculated using beat signal from target path optics 406 to linearize its unwrapped phase evolution over its acquisition time. This correction function is applied to the beat signals from environment 407 for improving their unwrapped phase evolution linearity over the same data acquisition period. Once the correction is applied on the target signals 407, the corrected beat note is sent to the rest of digital signal processing steps for generating and interpreting point cloud data for multi-dimensional mapping of the target environment.

The examples of systems, methods, components, and so forth described in this disclosure are to provide an understanding of presented embodiments. However, to one skilled in art at least some embodiments of this disclosure may be practiced without the given details. Some embodiments may vary from the given examples'details but still considered to be within this disclosure's scope. In some instances, common methods, sub-systems, components are not described in detail to avoid obscuring this disclosure.

The operations in this disclosure are presented in a particular order. However, these operations may be performed in any other order or in an alternating manner, all of which are within the scope of present disclosure. The descriptions in the presented disclosure and example implementations, including the figures and the abstract, are not limited to precise forms disclosed. These examples and descriptions are for illustrative purposes and equivalent modifications that are recognizable by one skilled in the relevant art are also within the scope of this invention.

The phrase “one embodiment” and “an embodiment” are used to describe a specific part or feature is in connection with at least one embodiment which may be any one of the listed embodiments not a single specific one. The word “example” is used to mean serving as an instance, example or illustration and is intended to present concepts not necessarily a preferred over other instance. The word “or” is intended to be an inclusive “or” not an exclusive “or”. The words “a” and “an” are intended to mean “one or more” unless it may be clear from the context to be singular or otherwise specified. Similarly, the words “first,” “second,” etc. are used to differentiate between elements, not by their ordinal meaning.

What is claimed is:

1. A coherent detection system for sensors like LIDAR or OCT and a method for self-calibration of target path beat signal imperfections of these sensors without using an additional interferometer, detectors or any additional beat signal from a non-target path source.

2. The method of claim 1 uses any naturally occurring or intentionally generated reflection or reflections coming back from the target path components is used for mixing with the light from the refence path or local oscillator for calculating and calibrating out beat signal imperfections and non-linearities.

3. The method of claim 1 calibrates out target path beat signal imperfections using a reflection that occurs at the target path's fiber tip which has a surface interface of fiber core and air with a refractive index mismatch at a known range.

4. The method of claim 1 calibrates out target path beat signal imperfections using a reflection that occurs at the target path with in or at the exit of a PIC or at the remainder of the target path that is outside the PIC.

5. The method of claim 1 calibrates out target path beat signal imperfections using a reflection that occurs at one of the optical components within the target path such as a lens, wave plate, a polarization sensitive splitter, a window, a mirror or any partial or full reflector from a known range.

6. The method of claim 1, when no natural reflection returns from the target path that is usable for self-calibration, calibrates out target path beat signal imperfections using a reflection from a partially or fully reflective component that is intentionally inserted or added to the target path with in the apparatus and has partial spatial coverage on the target path for generating a calibration beat signal when mixed with the light from reference path or local oscillator.

7. The method of claim 6, a partially reflective component that has partial or full spatial coverage on the target path is inserted in the target path for generating a beat signal when mixed with the light from reference path or local oscillator.

8. The method of claim 2, calibration beat signal coming from within the target path is isolated from environment targets using its frequency range and imperfections or non-linearities are removed by using its wrapped or unwrapped phase information to linearize the evolution of its phase over the acquisition period.

9. The method of claim 2, the calibration of beat signal phase is performed by using the zero crossings of each sinusoidal-like wave.

10. The method of claim 2, the calibration of beat signal phase is performed by using the peak locations of each sinusoidal-like wave.

11. The method of claim 2, the calibration of beat signal phase is performed by using a sine wave curve fitting to sinusoidal-like waves.

12. The method of claim 2, a multiplexed version of any one or combination of the above claims are used to obtain calibration or calibrations for multiple optical beams from coherent or non-coherent optical source or sources separated by frequency, wavelength, polarization state or multiplexing with any other method.

13. The method of claim 2, the light power is amplified prior to entering the target path for any one or combination of the above claims are used to obtain calibration or calibrations for single or multiple optical beams.
